(19) United States
(12) Patent Application Publication
(10) Pub. No.: US 2022/0024134 A1
(43) Pub. Date: Jan. 27, 2022

(54) PREDICTING THE SHAPE OF A THREE-DIMENSIONAL OBJECT WHICH IS SUBJECTED TO A DIFFUSION PROCESS

(71) Applicant: COMMISSARIAT A L'ENERGIE ATOMIQUE ET AUX ENERGIES ALTERNATIVES, Paris (FR)

(72) Inventor: Jérôme HAZART, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 17/413,718

(22) PCT Filed: Dec. 17, 2019
(86) PCT No.: PCT/FR2019/053117

§ 371 Date: Jun. 14, 2021

(30) Foreign Application Priority Data
Dec. 19, 2018 (FR) 1873368

(51) Int. Cl. B29C 64/386; B33Y 50/00; B29C 71/00; B29C 71/02; B33Y 40/20; G06F 17/14; G05B 19/4099

(52) U.S. Cl. CPC B29C 64/386; B33Y 50/00; B29C 71/0009; B29C 64/124; B33Y 40/20; G06F 17/14; G05B 19/4099; B29C 71/02

(57) ABSTRACT

The present invention relates to a method for predicting the shape of a three-dimensional object which has been subjected to a diffusion process for a predetermined duration. The prediction method uses a law of vertical morphing and a law of lateral morphing. The law of lateral morphing applies to a description of the contours of different slices of a sample at standardised heights. The description of the contour of a slice is obtained by a curvilinear Fourier transform of the contour or by a two-dimensional spatial Fourier transform of a contour line approximating said contour. The present invention also relates to the manufacture of a three-dimensional object of a given material and a given nominal shape.

### TECHNICAL FIELD

The present invention generally relates to the field of manufacturing three-dimensional objects from an initial shape for undergoing a diffusion process, and more particularly to a method for predicting the shape of such objects at the end of said process.

### STATE OF THE ART

Numerous techniques for additive manufacturing of three-dimensional objects have emerged in recent years. These techniques generally involve the deposition of successive layers undergoing a physical transformation such as polymerisation, for example. Thus, EP-A-820855 describes a method for manufacturing three-dimensional objects from successive layers obtained by stereolithography and undergoing polymerisation under the effect of energetic radiation.

Whatever the technique used, it is known to conduct a reflow on the object formed by these successive layers. However, the final shape of the object after reflow is difficult to determine in advance, especially when the diffusion coefficient of the material and the reflow time are high. It is therefore necessary to carry out lengthy and costly test runs, with layers of different shapes and different relative positions before the desired final shape is reached.

A purpose of the present invention is therefore to provide a method for predicting the shape of a three-dimensional object after it has undergone a diffusion process. A subsidiary purpose of the present invention is to provide a method for manufacturing a three-dimensional object of a predetermined shape set point and a given material, from a given initial shape.

### DISCLOSURE OF THE INVENTION

The present invention is defined by a method for predicting the shape of a three-dimensional object subjected to a diffusion process for a predetermined period of time, characterised in that it comprises:
a calibration phase in which a plurality of samples of different initial shapes undergo, for said determined period of time, the diffusion process, at the end of which the samples assume final shapes, and comprising, for each sample:

a) measuring the initial height of the sample and acquiring first contours of a plurality of horizontal slices of the sample in its initial shape, at heights normalised by the initial height;

b) measuring the final height of the sample and acquiring second contours of the same plurality of horizontal slices of the sample in its final form, at heights normalised by the final height, equal to said heights normalised by the final height;

c) estimating the parameters of a vertical morphing law for switching from the initial height to the final height and estimating the parameters of a lateral morphing law for switching from a representation, in a Fourier space, of the first contours to a representation, in this same space, of the second contours;
a prediction phase comprising:

d) estimating the final height of said object from its initial height and the parameters of the vertical morphing law;

e) obtaining a representation in said Fourier space of a plurality of contours of the slices of the object in its initial form, at said normalised heights;

f) obtaining a representation in said Fourier space of a plurality of contours of the slices of the object in its final shape, at said normalised heights, from said representation of the slices of the object in its initial shape and the parameters of the lateral morphing law;

g) determining the contours of the plurality of slices of said object in its final form, at the normalised heights, from the representation of the contours of these slices in said Fourier space obtained in step (f);

h) obtaining the final shape of the three-dimensional object from the final height of said object and the contours of the slices of said object in its final shape, previously determined at the normalised heights.

According to a first embodiment, the representation in said Fourier space of the first and second contours in step (c) as well as the representation, in this same space, of the contours of the slices of the object in its initial shape in step (f), is obtained by a curvilinear Fourier transform of these contours.

Conversely, in step (g), determining the contours of the plurality of slices of said object in its final form is achieved by an inverse curvilinear Fourier transform of the representation of the contours of these slices in said Fourier space obtained in step (f).

According to a second embodiment, the representation in said Fourier space of the first and second contours in step (c) as well as the representation in this space of the contours of the slices of the object in its initial form in step (f), is obtained by performing the following steps of:

(f1) selecting a plurality of points of this contour, and determining the normals of this contour at these points;

(f2) calculating the coefficients of a two-dimensional spatial Fourier transform of a level curve function taking a zero value at the points thus selected and whose normals at these points are respectively equal to the normals of the contour at these same points.

Conversely, in step (g), determining the contours of the plurality of slices of said object in its final form is achieved by performing an inverse two-dimensional spatial Fourier transform of the coefficients calculated in step (f2).

The invention is also defined by a method for manufacturing a three-dimensional object of a given material and having a given shape set point, the manufacturing method comprising a calibration phase in which a database of parameters of a vertical morphing law and a lateral morphing law for a plurality of normalised heights of said samples is constructed from measurements of samples of said material, before and after a diffusion process with a period of time T, then a prediction method as defined above is applied to a plurality of initial shapes to predict their respective final shapes at the end of the diffusion process, and the initial shape whose corresponding final shape is closest to said shape set point relative to a predetermined distance is selected, a three-dimensional object having the initial shape thus selected is made, and finally the diffusion process for the period of time T is applied to obtain a three-dimensional object having said shape set point.

### BRIEF DESCRIPTION OF THE DRAWINGS

Further features and advantages of the invention will become apparent from a preferred embodiment of the invention, described with reference to the accompanying figures, among which:

FIG. 1 schematically represents the initial shape of a three-dimensional object;

FIG. 2 schematically represents the shape of the three-dimensional object of FIG. 1 after it has undergone a diffusion process;

FIG. 3A and FIG. 3B represent the flowchart of a method for predicting, according to a first embodiment, the shape of a three-dimensional object that has undergone a diffusion process;

FIG. 4A and FIG. 4B represent the flowchart of a method for predicting the shape of a three-dimensional object that has undergone a diffusion process, according to an alternative of the first embodiment;

FIG. 5A and FIG. 5B represent the flowchart of a method for predicting, according to a second embodiment, the shape of a three-dimensional object that has undergone a diffusion process;

FIG. 6A and FIG. 6B represent the flowchart of a method for predicting the shape of a three-dimensional object that has undergone a diffusion process, according to an alternative of the second embodiment;

FIG. 7 represents a flow chart of a method for manufacturing a three-dimensional object of a given material and a predetermined shape set point.

### DETAILED DISCLOSURE OF PARTICULAR EMBODIMENTS

In the following, a three-dimensional object with a given initial shape and a given material will be considered. This object may, for example, have been produced by means of an additive manufacturing technique or by 3D photolithography. The material may be, for example, a polymer.

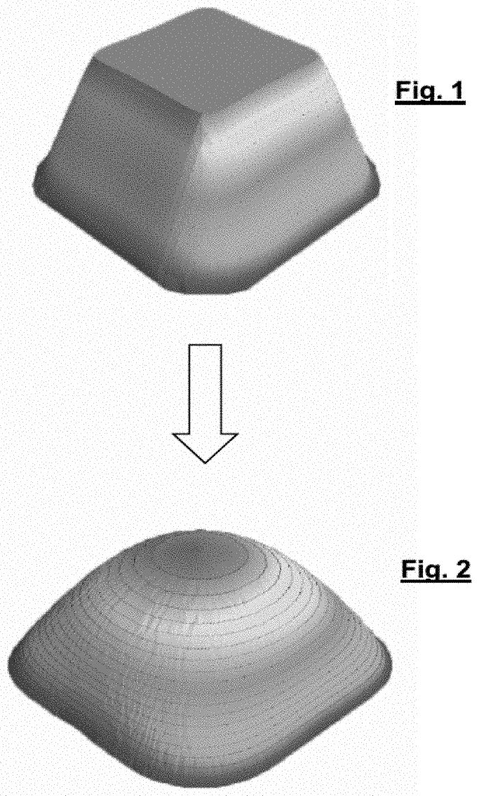

A perspective view of such an object, having total height hₘₐₓ, has been represented in FIG. 1. This object can be divided into successive horizontal slices designated by Cₗ, [symbol] =1, . . . , L, each slice being characterised by its own contour in the horizontal plane.

It is assumed that this object undergoes a transformation by means of a diffusion process of physical or even physico-chemical origin. This diffusion process can be, for example, a reflow, such as a thermal reflow of the constituent material of the object, or an erosion of this material in the presence of a solvent in the gas phase.

FIG. 2 represents the three-dimensional object of FIG. 1 after it has undergone a diffusion process for a time T. As a result of the diffusion process and gravity, the shape of the object changed: the shape was overall collapsed and the zones corresponding to high spatial frequencies were smoothed.

The idea underlying the present invention is to model the shape transformation (also called morphing) of the three-dimensional object. It is important to understand that this modelling is not to model the underlying physical process but simply the change in shape resulting from the application of the process.

In an original way, the evolution of the shape of the object is modelled, on the one hand, by a first law giving the total height of the object in time and, on the other hand, by a second law describing the evolution of the contour of a horizontal slice of the object in time.

The height of the three-dimensional object depends on time and is therefore denoted by h(t), h(0)=hₘₐₓ designating the initial height of the object and h(T) the height of the object after it has undergone a diffusion process for a time T.

It has been shown that when the object has a vertical axis of symmetry, the height h(T) of the object at the end the diffusion process varies as a function of the initial height of the object and the radius rip of the circle equivalent to the base of the object. By circle equivalent to the base of the object it is meant a circle whose area is equal to the area of the base of the object.

h(T)=h(0)H(r₀,T) (1)

with:

H(r₀,T),a(T)r₀ exp(−b(T)r₀) (2)

where a(T),b(T) are strictly positive coefficients depending on the material used and the period of time of the diffusion process, T, more simply noted a,b in the following. The expression H(r₀,T) is referred to in the following as the vertical morphing factor relative to the period of time T.

A horizontal slice of the object, located at a height Z relative to its base is then considered. Let \tilde{z}=z/h be the normalised height of the slice. This normalised height remains unchanged during the diffusion process. The contour of the slice is noted ϕ(t), as it changes during the diffusion process. The contour ϕ(t) is represented as a function of its curvilinear abscissa and u can be expanded as a curvilinear Fourier series, namely:

$$\begin{matrix}x ( u , t ) = {x}_{0} ( t ) + {\sum }_{k = 1}^{N} {a}_{k} ( t ) cos 2 π k u + {b}_{k} ( t ) sin 2 π ku & ( 3 \text{-} 1 ) \\ y ( u , t ) = {y}_{0} ( t ) + {\sum }_{k = 1}^{N} {c}_{k} ( t ) cos 2 π k u + {d}_{k} ( t ) sin 2 π ku & ( 3 \text{-} 2 )\end{matrix}$$

where (x(u,t) y(u,t)) are the Cartesian coordinates of a point P(u,t) of the contour ϕ(t) with curvilinear abscissa u and aₖ(t), bₖ(t), cₖ(t) dₖ(t) are the Fourier coefficients corresponding to the spatial frequency. It will be noted that these Fourier coefficients are time-dependent insofar as the slice contour ϕ(t) changes over time due to the application of the diffusion process.

Equations (3-1) and (3-2) can be expressed in a more compact way using complex coordinates:

$$ϕ ( u , t ) = x ( u , t ) + j y ( u , t ) = {\sum }_{k = - N}^{N} {ϕ}_{k} ( t ) exp j 2 π ku \qquad ( 4 )$$

where ϕ₀(t)=x₀(t)+jy₀(t) represents the evolution of the centre of gravity of the contour, ϕ₁(t) represents the evolution of the equivalent ellipse, that is best approximating the contour of the slice.

When the slice is isolated, the centre of gravity of the contour has no reason to move and it can be assumed, without loss of generality, that it is coincident with the origin, that is ϕ₀(t)=0.

The diffusion process tends to make the contour of the slice circular. In other words, the equivalent ellipse tends towards a circle and:

$${ϕ}_{1} ( ∞ ) = {r}_{∞} ( \tilde{z} ) ( \frac{1 + j}{\sqrt{2}} ) \qquad ( 5 )$$

where r_{∞}(\tilde{z}) is the radius of the contour of the slice considered at the normalised height 2 after infinite time.

More generally, it is assumed that after infinite time the slice contracts laterally by a coefficient s(\tilde{z}):

|ϕ₁(∞)|=r_{w}(\tilde{z})=s(\tilde{z})·|ϕ₁(0)=s(\tilde{z})·r₀(\tilde{z}) (6)

The coefficient s(\tilde{z}) will be referred to as the contraction coefficient in the following. The contraction coefficient depends on the normalised height at which the slice is located in the three-dimensional object. Indeed, due to the diffusion process the shape of the object after an infinite time is that of a truncated sphere. As a result s(1)=0, since the top of the sphere can be considered as a slice having zero size. On the other hand, the coefficient s(0) can be greater than 1, that is the base can expand in time.

Since the contour of the slice tends to a circle, the power of the harmonics with rank |k|>1 tends to zero when time tends to infinity, that is:

ϕₖ(∞)=0,∀k,|k|>1 (7)

It is assumed that the power of the harmonics exponentially decreases with time, the quickness of the decrease depending on the rank k of the harmonic, that is:

ϕₖ(t)=ϕₖ(0)exp(−α|k|^{γ}t) (8)

where α et γ are strictly positive real numbers.

In summary, it can be written in a condensed way:

ϕₖ=ϕₖ(0)exp(−α|k|^{γ}t)+ϕₖ(∞)(1−exp(−α|k|^{γ}t)),∀k,|k|>1 (9)

with |ϕ₁(∞)|=s(\tilde{z})·|ϕ₁(0)| and ϕₖ(∞)=(1−δ(k−1)ϕ₁(∞)+(1−δ(k+1)ϕ₋₁(∞) where δ is the Dirac symbol.

Equivalently, this is:

ϕₖ(t)=Mₖ(t)·ϕₖ(0)+(1−Mₖ(t))·ϕₖ(∞) (10)

Where Mₖ(t)=exp (−α|k|^{r}t) is the lateral morphing factor for the harmonic with rank |k|.

If an isolated slice is now no longer considered but rather all the slices of the object, it be taken into account the fact that the centres of gravity of these different slices, noted ϕ₀^{t} (t), where l represents the index of the slice, are not aligned at the initial time t=0. Furthermore, the slices may interact with each other and the centres of gravity of the different slices may drift in time.

In simple shape cases, it can be legitimately assumed that the slices are independent and their centres of gravity remain fixed in time. It is then possible to describe the evolution of these slices by:

[symbol]

(t)= [symbol] (t) [symbol] (0)+(1− [symbol] (t))· [symbol] (∞), [symbol] =1, . . . ,L (11)

where [symbol] (t)=exp(− [symbol] [symbol] t) is the morphing factor relative to the slice [symbol] and where [symbol] and [symbol] are the coefficients α and γ relating to the layer [symbol] , [symbol] (∞)|= [symbol] ·| [symbol] (0)| and [symbol] (∞)=(1−δ(k−1) [symbol] (∞)+(1−δ(k+1)) [symbol] (∞) where s^{(l)} is the contraction factor relating to the layer [symbol] .

However, in other cases, especially when the slice contours are concave, for example U-shaped, the slice independence hypothesis is not realistic. In extreme cases, this independence hypothesis leads to aberrant results, such as the case where an upper slice is not fully supported by a lower slice.

In an original way, the dependence between slices is treated as an energy minimisation problem, the interaction energy between two successive slices being high when they do not overlap and low when they do.

It is noted that, when the slices are independent, the evolution of the curvilinear harmonics of the different contours can be obtained from equation (8):

$$\frac{d {ϕ}_{k}^{( ℓ )} ( t )}{d t} = - {α}^{( ℓ )} {\vert k \vert}^{{γ}^{( ℓ )}} {ϕ}_{k}^{( ℓ )} ( t ) ∀ k , \vert k \vert > 1 \qquad ( 12 )$$

On the other hand, when two successive slices [symbol] and [symbol] are coupled together, the evolution of the contours of these slices is governed by the coupled differential equations:

$$\begin{matrix}\frac{d {ϕ}_{k}^{( {ℓ}_{1} )} ( t )}{dt} = - {α}^{( {ℓ}_{1} )} {\vert k \vert}^{{γ}^{( {ℓ}_{1} )}} {ϕ}_{k}^{( {ℓ}_{1} )} ( t ) - {C}_{k} ( {ϕ}_{k}^{( {ℓ}_{1} )} ( t ) - {ϕ}_{k}^{( {ℓ}_{2} )} ( t ) ) & ( 13 \text{-} 1 ) \\ \frac{d {ϕ}_{k}^{( {ℓ}_{2} )} ( t )}{dt} = - {α}^{( {ℓ}_{2} )} {\vert k \vert}^{{γ}^{( {ℓ}_{2} )}} {ϕ}_{k}^{( {ℓ}_{2} )} ( t ) - {C}_{k} ( {ϕ}_{k}^{( {ℓ}_{2} )} ( t ) - {ϕ}_{k}^{( {ℓ}_{1} )} ( t ) ) & ( 13 \text{-} 2 )\end{matrix}$$

These equations can be written more compactly in matrix form:

$$\frac{d {Φ}_{k} ( t )}{d t} = - {A}_{k} {Φ}_{k} ( t ) \qquad ( 14 )$$

where Φₖ(t) is a vector having size L whose elements are the curvilinear harmonics with rank k: [symbol] (t), Aₖ is a symmetric tri-diagonal matrix having size L×L whose main diagonal terms are equal to − [symbol] [symbol] −Cₖ and whose lower and upper diagonal terms are equal to Cₖ, where [symbol] and [symbol] are strictly positive parameters and Cₖ is a coupling coefficient for the harmonic with rank k between two successive slices of the sample.

In the absence of coupling, that is when the slices are independent, the matrix Aₖ reduces to a simple diagonal matrix. Conversely, the coupling may extend beyond the immediately lower slice and the immediately upper slice, in which case the matrix has upper and lower sub-diagonals comprised of non-zero terms. In practice, however, a coupling with the immediately lower slice and the immediately upper slice is usually sufficient to describe the evolution of the contours of the different slices of the object.

As a result of equation (14):

Φₖ(t)=exp(Aₖt)Φₖ(0)∀k,|k|>1 (15)

where

$$exp ( {A}_{k} t ) = {I}_{L} + {\sum }_{i = 1}^{+ ∞} {( {A}_{k} )}^{i} \frac{{t}^{i}}{i !}$$

with I_{L} the identity matrix having size L×L.

In a similar way, with the same conventions as above:

Φ₁(t)=exp(A₁t)Φ₁(0)+(I_{L}−exp(A₁t))Φ₁(∞) (16)

The above model enables the shape of a three-dimensional object to be predicted, after it has undergone a diffusion process for a predetermined period of time T

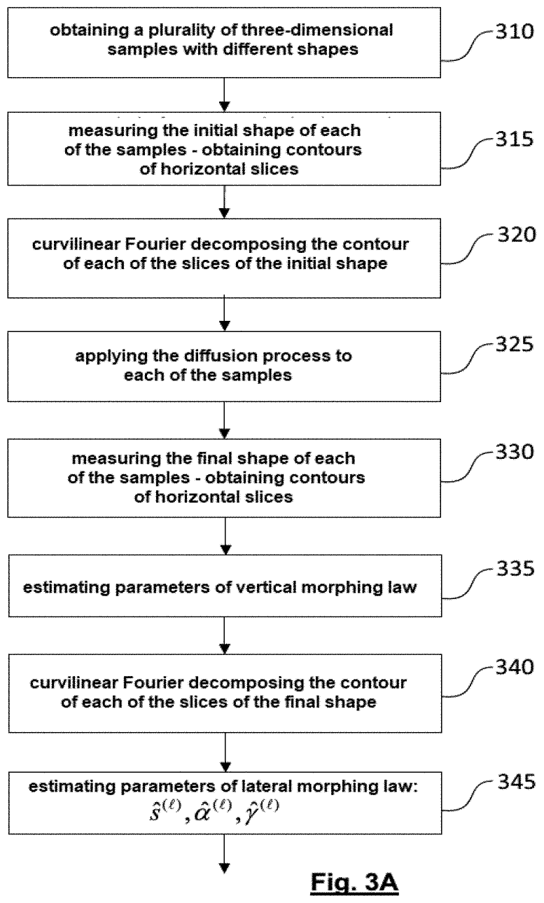

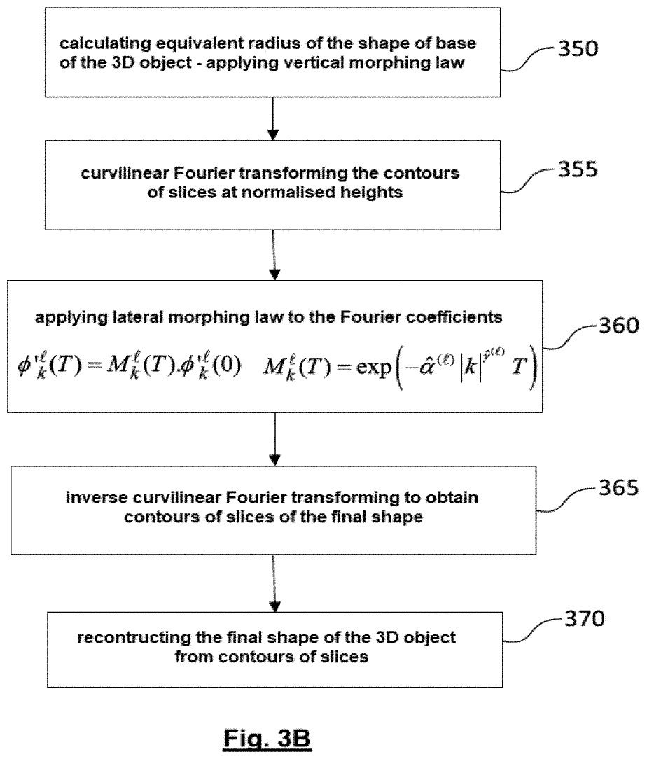

FIGS. 3A-3B represent the flowchart of a method for predicting, according to a first embodiment, the shape of a three-dimensional object that has undergone a diffusion process for a predetermined period of time.

The prediction method first comprises a calibration phase comprising steps 310-345 in FIG. 3A.

In step 310, a plurality of samples of three-dimensional objects with different heights are available. These samples also advantageously have different profiles.

In step 315, the initial shape of each of the samples is measured, for example using an atomic force microscope (AFM). The height of each sample is measured and divided into L intervals, each interval defining a horizontal slice [symbol] of the object located at a normalised height, [symbol] . From the measurement of the initial shape, the contour of each slice [symbol] =1, . . . , L is obtained. In step 320, a curvilinear Fourier decomposition of the contour of each of these slices is performed.

In step 325, the diffusion process is applied to the different samples for a period of time T.

In step 330, the final shape of each of the samples is measured, preferably by the same means as previously. The new heights of the samples and the contours of the slices located at the same normalised heights as previously are deduced.

In step 335, the coefficients of the vertical morphing law are estimated. More precisely, from the heights measured in step 330 and the equivalent radii of the slices forming the base of the samples, obtained in step 315, the coefficients a, b of expression (2) are determined, using a curve fitting technique.

The lateral morphing law is then estimated.

To do this, a curvilinear Fourier decomposition of each of the contours of the slices [symbol] , [symbol] =1, . . . , L, as obtained in step 330, is performed for each of the samples in step 340.

In step 345, a curve fitting technique is used to determine for each slice [symbol] the parameters [symbol] , [symbol] , [symbol] that minimise the square error between the values ϕₖ(T) given by the model (expression (11)) and the corresponding experimental values. An estimate of these parameters [symbol] , [symbol] , [symbol] is thus obtained.

Advantageously, a polynomial regression could be used to estimate these parameters. More precisely, it has been heuristically observed that the parameters s,α,γ can be expressed as a function of the normalised height \tilde{z}=z/hₘₐₓ, where Z is the height of the slice considered and hₘₐₓ=h(0) is the height of the initial sample.

α=P₂(\tilde{z}) (17-1)

γ=P₃(\tilde{z}) (17-2)

s=P₄(\tilde{z})\sqrt{1−\tilde{z}²} (17-3)

where P₂ (\tilde{z}), P₃ (\tilde{z}), P₄ (\tilde{z}) are respectively polynomials of degree 2, 3 and 4 of the normalised height 2. It can be seen that, in expression (17-3), the contraction coefficient is zero for \tilde{z}=1. In other words, as soon as the period of time T is long enough, the slice at the top of the three-dimensional object reduces to a point.

In practice, the values of the parameters s,α,γ are estimated for a plurality L of normalised heights (possibly several estimates relating to a same normalised height can come from different samples) and the coefficients of the polynomials are then calculated to minimise the root mean square deviation of the parameter values thus estimated.

The calibration phase is followed by an actual prediction phase, comprising steps 350-370 in FIG. 3B.

The prediction phase aims at predicting the shape of a three-dimensional object (with a given initial shape) after it has undergone the diffusion process for a period of time T. The initial shape of the object is characterised by its total height, hₘₐₓ^{′}, on the one hand, and by the contours of the horizontal slices of the object located at the normalised height values \tilde{z}ₜ, [symbol] =1, . . . , L, on the other hand.

In step 350, the equivalent radius, r₀^{′}, of the slice ( [symbol] =1) at the base of the object is calculated and the height of the object at the end of the diffusion process is determined from the vertical morphing law:

h′(T)=h′(0)H(r₀′,T) (18)

In step 355, the slices [symbol] with normalised heights [symbol] , [symbol] =1, . . . , L are considered. In this step, a curvilinear Fourier transform of the contours of these slices is performed and the complex coefficients [symbol] (0), k=−N, . . . , N, [symbol] =1, . . . , L are obtained.

In step 360, the contours of the slices [symbol] =1, . . . , L at the end of the diffusion process are determined from the lateral morphing law. More precisely, the coefficients) [symbol] (T) of the harmonics with rank |k|>1 are calculated by means of:

[symbol]

(T)= [symbol] (T)· [symbol] (0) for |k|>1 (19)

with [symbol] (T)=exp(− [symbol] [symbol] T) where [symbol] , [symbol] were obtained in the calibration phase.

Similarly, the coefficients [symbol] (T) for the fundamental frequency |k|=1 are calculated using:

[symbol]

(T)= [symbol] [symbol] (0) (20)

where the contraction coefficients [symbol] , [symbol] =1, . . . , L, were obtained in the calibration phase.

In step 365, an inverse curvilinear transform is performed to calculate the contour of each slice:

$${ϕ}^{′ℓ} ( u , T ) = {\sum }_{k = - N}^{N} {ϕ}_{k}^{′ℓ} ( T ) exp ( - j 2 π k u ) \qquad ( 21 )$$

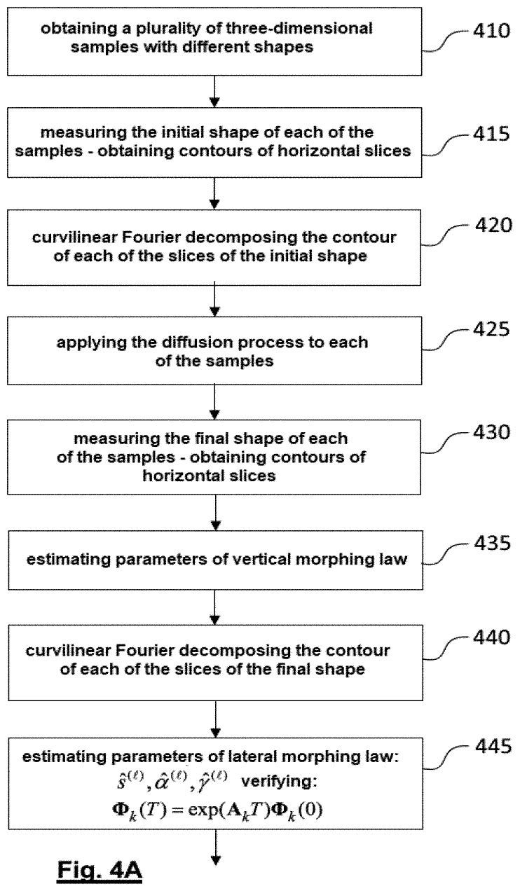

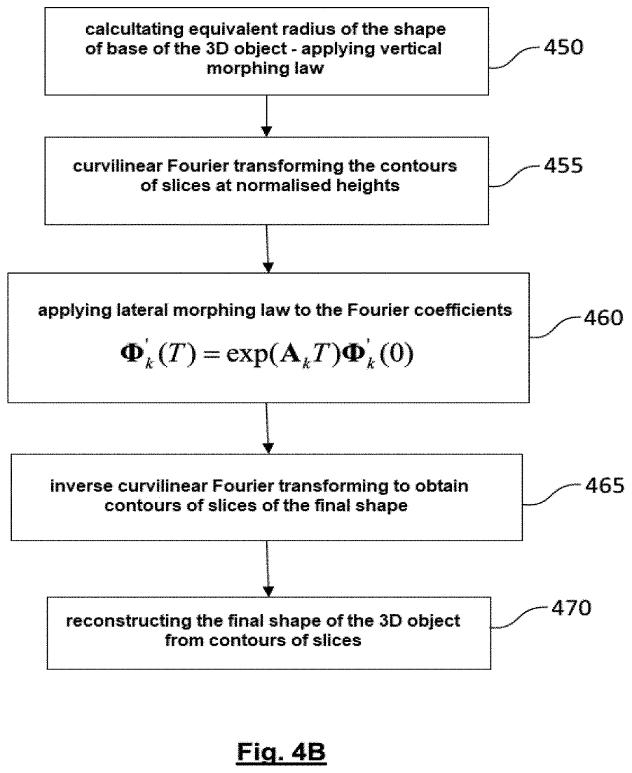

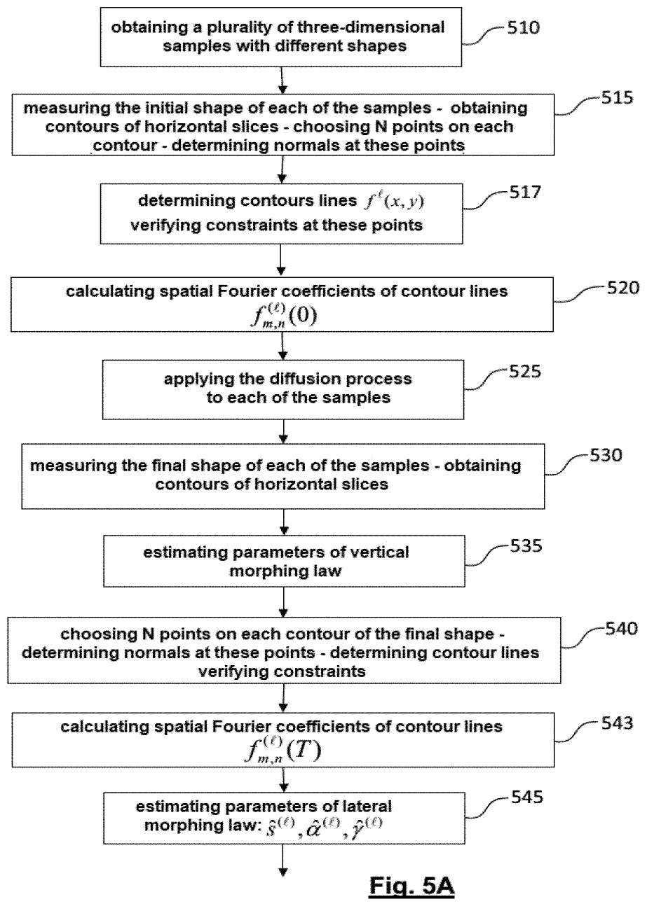

Finally, in step 370, the shape of the three-dimensional object is reconstructed from the contours of the slices [symbol] , [symbol] =1, . . . , L, obtained in step 365, these slices now being located respectively at the heights h′(T) [symbol] , [symbol] =1, . . . , L. FIGS. 4A-4B schematically represent the flowchart of a method for predicting the shape of a three-dimensional object that has undergone a diffusion process, according to an alternative of the first embodiment.

In this alternative, the slices of a three-dimensional object are no longer assumed to be independent and calibration is performed jointly on all slices of each sample.

As previously, the prediction method includes a calibration phase (FIG. 4A) before the actual prediction phase (FIG. 4B).

Steps 410-440 are respectively identical to steps 310-340 and their description will not be repeated here.

In step 445, the coefficients [symbol] , [symbol] , [symbol] =1, . . . , L and Cₖ are estimated, verifying for each of the samples:

Φₖ(T)=exp(AₖT)Φₖ(0) (22)

where the tri-diagonal matrix Aₖ has as diagonal terms − [symbol] [symbol] −Cₖ and as elements of the lower and upper diagonals, the constant term Cₖ, Φₖ(T) is a vector having size L whose elements are the curvilinear harmonics with rank k of the contours of the different slices of the sample at the end of the application of the diffusion process and Φₖ(0) is a vector having size L whose elements are the curvilinear harmonics with rank k of the contours of the different slices of the initial sample.

In practice, solving the system of equations (22) is done by curve fitting considering only the first terms of the expansion in series of exp(AₖT).

The actual prediction phase comprises steps 450-470. As previously, it aims at predicting the shape of a three-dimensional object (with a given initial shape) when it has undergone the diffusion process for a period of time T.

The step 450 of determining the height of the three-dimensional object, by means of the vertical morphing law whose coefficients have been estimated in the calibration phase, is identical to step 350.

In step 455, the complex coefficients ϕₖ^{l} [symbol] (0), k=−N, . . . ,N [symbol] =1, . . . , L, of the curvilinear Fourier transform of the contours of the slices C [symbol] ^{′}, [symbol] =1, . . . , L, of the three-dimensional object are obtained as in step 355, and then vectors Φₖ^{′}, |k|>1, whose elements are the coefficients [symbol] (0), [symbol] =1, . . . , L are formed.

In step 460, the contours of the slices [symbol] , [symbol] =1, . . . , L at the end of the diffusion process are determined from the lateral morphing law. More precisely, the vectors Φₖ^{′}(T), |k|>1 are calculated by means of:

Φₖ^{′}(T)=exp(AₖT)Φₖ⁴⁰(0) (23)

where the matrix Aₖ was determined in the calibration phase.

The elements of each vector Φₖ^{′}(T), |k|>1, give the coefficients of the harmonics with rank k, [symbol] (T), of the different slices [symbol] = [symbol] =1, . . . , L.

Furthermore, the coefficients [symbol] (T), of the different slices [symbol] , [symbol] =1, . . . , L, for the fundamental frequency |k|=1 are calculated from the expression (20) as in step 360.

Steps 465 and 470 are identical to steps 365 and 370 respectively. In other words, the inverse curvilinear Fourier transform of [symbol] (T), k=−N, . . . , N, is calculated in 465 to obtain the contours of the different slices and the shape of the object is finally reconstructed in 470.

According to a second embodiment of the invention, the representation of the contours of the slices of the three-dimensional object does not use a curvilinear Fourier series decomposition but a method of level surfaces, expanded in Fourier coefficients. In general, methods of level surfaces allow the evolution of an interface to be represented. A one-dimensional interface Γ or level line, bounding at instant t a region C in a plane is defined by an equation of the type:

F(x,y,t)=0 (24)

where the function F is a smooth function, positive inside the curve Γ (thus on Ω) and negative outside it.

A given instant t₀ is now considered and the function defining the curve Γ at that instant is noted ƒ(x,y). The knowledge of a number of points belonging to this curve and the normals to the curve at this point make it possible to calculate the (spatial) Fourier coefficients of the function ƒ(x,y).

Indeed, given a set of N points Pᵢ, i=1, . . . , N, with coordinates (xᵢ,yᵢ) belonging to the curve Γ and Nᵢ=(vᵢ^{x},vᵢ^{y}) the vectors normal to this curve at these points, the function ƒ(x,y) has to verify the constraints:

$$\begin{matrix}f ( {x}_{i} , {y}_{i} ) = 0 ; ∀ i = 1 , … , N & ( 25 \text{-} 1 ) \\ \frac{\partial f}{\partial x} ( {x}_{i} , {y}_{i} ) = {v}_{i}^{x} , \frac{\partial f}{\partial y} ( {x}_{i} , {y}_{i} ) = {v}_{i}^{y} ; ∀ i = 1 , … , N & \end{matrix}$$

The function ƒ(x,y) can be expanded in spatial Fourier series:

$$f ( x , y ) = {\sum }_{m , n} {f}_{m , n} exp ( j {k}_{x} mx + j {k}_{y} n y ) \qquad ( 26 )$$

avec and kₓ=2π/Lₓ and k_{y}=2π/L_{y} where Lₓ et L_{y} are the dimensions of a rectangle including the curve, that is kₓ and k_{y} are the lowest spatial frequencies along the x- and y-axes of and to describe the curve Γ.

As a result of expression (26):

$$\begin{matrix}\frac{\partial f}{\partial x} ( x , y ) = {\sum }_{m , n} j {k}_{x} m {f}_{m , n} exp ( {jk}_{x} mx + {jk}_{y} ny ) \\ and & ( 27 \text{-} 1 ) \\ \frac{\partial f}{\partial y} ( x , y ) = {\sum }_{m , n} {jk}_{y} {nf}_{m , n} exp ( j {k}_{x} mx + j {k}_{y} n y ) & ( 27 \text{-} 2 )\end{matrix}$$

Constraints (25-1) and (25-2) can then be rewritten as 3N equations that the Fourier coefficients f_{m,n} have to verify:

$$\begin{matrix}{\sum }_{m , n} {f}_{m , n} exp ( j {k}_{x} m {x}_{i} + j {k}_{y} n {y}_{i} ) = 0 ; ∀ i = 1 , … , N & ( 28 \text{-} 1 ) \\ {\sum }_{m , n} j {k}_{x} m {f}_{m , n} exp ( j {k}_{x} {mx}_{i} + j {k}_{y} {ny}_{i} ) = {v}_{i}^{x} ; ∀ i = 1 , … , N & ( 28 \text{-} 2 ) \\ {\sum }_{m , n} j {k}_{y} n {f}_{m , n} exp ( j {k}_{x} {mx}_{i} + j {k}_{y} {ny}_{i} ) = {v}_{i }^{y} ; ∀ j = 1 , … , N & ( 28 \text{-} 3 )\end{matrix}$$

If the number of points N is sufficient, the coefficients can be determined for a predetermined number of harmonics. More precisely, if it is desired to go to harmonics with rank αₓ,β_{y},

$$N \geq \frac{4}{3} \cdot {α}_{x} ,$$

β_{y} fly points will be needed on curve Γ.

In the following, it will be assumed that αₓ=β_{y} and Q=2αₓ=2β_{y} will be noted.

The previous equations (28-1), (28-2), (28-3) can be represented in a more compact matrix form:

FEᵢ=0_{Q}

FWᵢ^{x}=vᵢ^{x}

FWᵢ^{y}=vᵢ^{y} (29)

where F is a matrix with size Q×Q whose elements are the Fourier coefficients, f_{m,n}, Eᵢ s a matrix with size Q×Q whose elements are the values exp(jkₓmxᵢ+jk_{y}nyᵢ), Wᵢ^{x} is a matrix with size Q×Q whose elements are the values jk_{y}n exp(jkₓmxᵢ+jk_{y}nyᵢ) 0_{Q} is a vector having size Q whose elements are zero, vᵢ^{x} is a vector having size Q whose elements are all equal to vᵢ^{x}, vᵢ^{y} is a vector having size Q whose elements are all equal to vᵢ^{y}.

When the curve Γ changes over time, the Fourier coefficients f_{m,n} are also functions of time and are then denoted f_{m,n}(t).

If the curve Γ is the contour of a horizontal slice of a three-dimensional object, the diffusion phenomenon induces a smoothing of the curve so that the power of the harmonics f_{m,n} (t) tends to zero, in other words as soon as \sqrt{m²+n²}>1, f_{m,n}(∞)=0.

As in the first embodiment, it is assumed that the power of the harmonics exponentially decreases with time, the quickness of the decrease depending on the rank of the harmonic, that is:

f_{m,n}(t)=f_{m,n}(0)exp(−α|k|^{y}t) with |k|=\sqrt{(mkₓ)²+(nk_{y})²} (30)

This leads to a evolution of the harmonics of the type shown in equation (10):

f_{m,n}(t)=M_{m,n}(t)·f_{m,n}(0)+(1−M_{m,n}(t))·f_{m,n}(∞) (31)

|f_{m,n}(∞)|=s(\tilde{z})·|f_{m,n} (0)| if \sqrt{m²+n²}=1 and f_{m,n} (∞)=0 if \sqrt{m²+n²}>1, where s(\tilde{z}) is the slice contraction factor as in the first embodiment, and where the lateral morphing factor M_{m,n}(t) is given by:

M_{m,n}=exp(−α|k|^{y}t)avec|k|=\sqrt{(mkₓ)²+(nk_{y})²} (32)

When the slices [symbol] =1, . . . , L of the three-dimensional object can be considered as independent, the evolution of the harmonics of the different contours can be obtained from equation (30):

$$\frac{d {f}_{m , n}^{ℓ} ( t )}{d t} = - α {\vert k \vert}^{γ} {f}_{m , n}^{ℓ} ( t ) ∀ m , n \sqrt{{m}^{2} + {n}^{2}} > 1 \qquad ( 33 )$$

where f_{m,n}^{t}(t) is the Fourier coefficient f_{m,n} (t) of the contour of a slice l of the sample.

On the other hand, when the slices are dependent, a coupling model between harmonics of the same rank of successive slices can be used, similarly to (13-1) and (13-2):

$$\begin{matrix}\frac{d {f}_{m , n}^{( {ℓ}_{1} )} ( t )}{d t} = - {α}^{( {ℓ}_{1} )} {\vert k \vert}^{{γ}^{( {ℓ}_{1} )}} {f}_{m , n}^{( {ℓ}_{1} )} ( t ) - {C}_{m , n} ( {f}_{m , n}^{( {ℓ}_{1} )} ( t ) - {f}_{m , n}^{( {ℓ}_{2} )} ( t ) ) & ( 34 \text{-} 1 ) \\ \frac{d {f}_{m , n}^{( {ℓ}_{2} )} ( t )}{d t} = - {α}^{( {ℓ}_{2} )} {\vert k \vert}^{{γ}^{( {ℓ}_{2} )}} {f}_{m , n}^{( {ℓ}_{2} )} ( t ) - {C}_{m , n} ( {f}_{m , n}^{( {ℓ}_{2} )} ( t ) - {f}_{m , n}^{( {ℓ}_{1} )} ( t ) ) & ( 34 \text{-} 2 )\end{matrix}$$

which can also be written in matrix form:

$$\frac{d {F}_{m , n} ( t )}{d t} = - {A}_{m , n} {F}_{m , n} ( t ) \qquad ( 35 )$$

where F_{m,n}(t) is a vector having size L whose elements are the spatial harmonics with m, n of the different layers: f_{m,n}^{(t)}(t), is a symmetric tri-diagonal matrix having size L×L whose main diagonal terms are equal to − [symbol] [symbol] −C_{m,n} and whose lower and upper diagonal terms are equal to C_{m,n}.

As a result, the vector F_{m,n}(t) can be written as:

F_{m,n}(t)=exp(A_{m,n}t)F_{m,n}(0)∀m,n\sqrt{m²+n²}>1 (36)

In a similar way, with the same conventions as above:

F_{0,1}(t)=exp(A_{0,1}t)F_{0,1}(0)+(I_{L}−exp(A_{0,1}t))F_{0,1}(∞) (37-1)

F_{1,0}(t)=exp(A_{1,0}t)F_{1,0}(0)+(I_{L}−exp(A_{1,0}t))F_{1,0}(∞) (37-2)

This model, like the one at the basis of the first embodiment, allows the shape of a three-dimensional object to be predicted, after it has undergone a diffusion process for a predetermined period of time T.

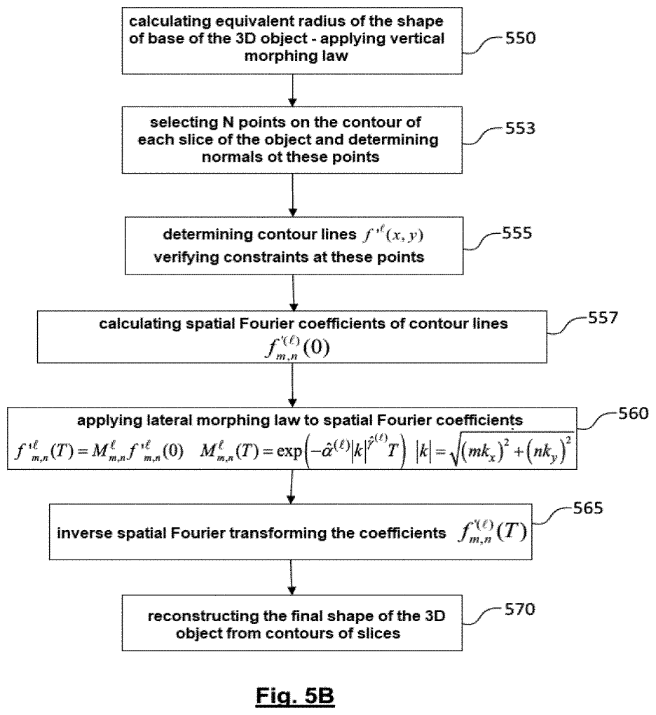

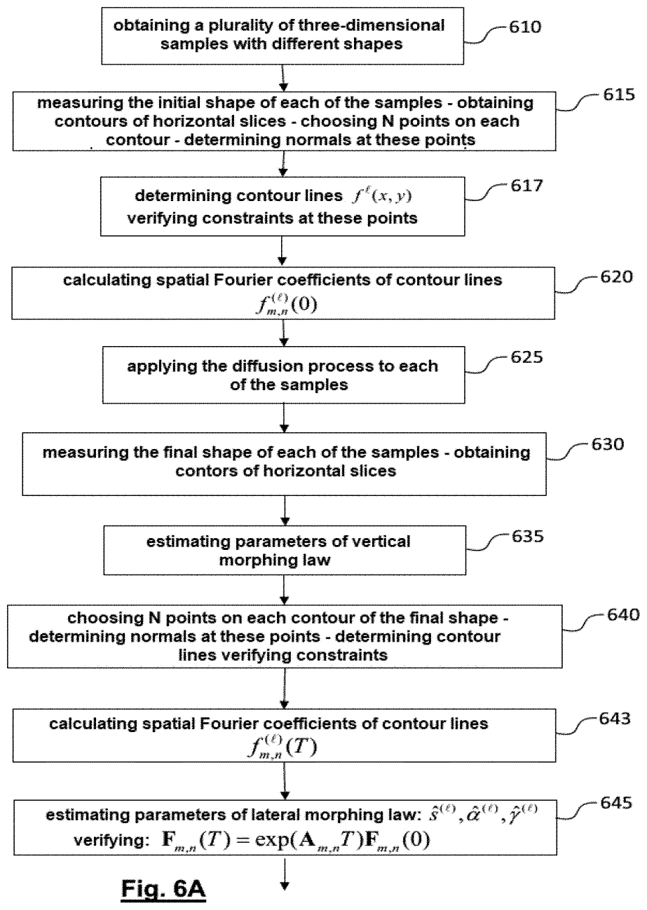

FIGS. 5A-5B represent the flowchart of a method for predicting, according to the second embodiment, the shape of a three-dimensional object that has undergone a diffusion process for a predetermined period of time.

The prediction method first comprises a calibration phase comprising steps 510-545 in FIG. 5A.

In step 510, a plurality of three-dimensional samples with different heights are available. These samples also advantageously have different profiles.

In step 515, the initial shape of each of the samples is measured, for example using an atomic force microscope (AFM). The height of each sample is measured and divided into L intervals, each interval defining a horizontal slice [symbol] of the object at a normalised height, [symbol] . On the contour [symbol] of each slice [symbol] , [symbol] =I, . . . , L, a plurality N of points [symbol] , i=1, . . . , N, with coordinates (xᵢ,yᵢ) belonging to the curve Γₗ are chosen and the normal vectors [symbol] =( [symbol] , [symbol] ) to the curve Γₗ at these points are determined. The points [symbol] are advantageously chosen to be equidistributed along the contour.

In step 517, the level curves [symbol] (x,y), [symbol] =1, . . . , L are determined, which verify the constraints:

$$\begin{matrix}{f}^{ℓ} ( {x}_{l}^{ℓ} , {y}_{i}^{ℓ} ) = 0 ; ∀ i = 1 , … , N & ( 38 \text{-} 1 ) \\ \frac{\partial {f}^{ℓ}}{\partial x} ( {x}_{i}^{ℓ} , {y}_{i}^{ℓ} ) = {v}_{i}^{x , ℓ} , \frac{\partial {f}^{ℓ}}{\partial y} ( {x}_{i}^{ℓ} , {y}_{i}^{ℓ} ) = {v}_{i}^{y , ℓ} ; ∀ i = 1 , … , N & ( 38 \text{-} 2 )\end{matrix}$$

In step 520, the spatial Fourier coefficients [symbol] (0) of [symbol] (x,y) are calculated for each of the samples, where the value 0 indicates that the three-dimensional object is considered at the initial time before the diffusion process is applied. For the calculation of the Fourier coefficients, the fundamental spatial frequencies kₓ=2π/Lₓ and k_{y}=2π/L_{y} where Lₓ and L_{y} are the dimensions of a rectangle including the projection of the object onto a horizontal plane are chosen. In step 525, the diffusion process is applied to the different samples for a period of time T.

In step 530, the final shape of each of the samples is measured by the same means as previously. The new heights of the samples and the contours of the slices located at the same normalised heights as previously are deduced.

In step 535, the coefficients of the vertical morphing law are estimated. More precisely, from the heights measured in step 530 and the equivalent radii of the slices forming the base of the samples, obtained in step 515, the coefficients a,b of expression (2) are determined, using a curve fitting technique.

The lateral morphing law is then estimated.

To do this, in step 540, a plurality of points [symbol] i=1, . . . , N with coordinates (xᵢ,yᵢ) belonging to the curve Γₗ are again chosen on the contour Γₗ of each slice [symbol] , [symbol] =1, . . . , L, and the normal vectors [symbol] =( [symbol] , [symbol] ) to the curve Fₗ at these points are determined. It will be understood, although the same notations have been adopted here for reasons of simplification as in step 515, that these are the contours after diffusion, at instant t=T. The level curves [symbol] (x,y), [symbol] =1, . . . , L, verifying the constraints (38-1) and (38-2) are determined, this time for the points [symbol] and the normal vectors [symbol] obtained in this same step, that is to say those relating to the contours of the slices at instant t=T.

In step 543, the spatial Fourier coefficients [symbol] (T) of the functions [symbol] (x,y) are calculated, where the value T indicates that the three-dimensional object is considered after the diffusion process has been applied. For this purpose, the same fundamental spatial frequencies kₓ,k_{y} are used as in step 520.

In step 545, a curve fitting technique is used to determine for each slice [symbol] the parameters [symbol] , [symbol] , [symbol] that minimise the square error between the values [symbol] (T) given by the model (expression (31)) and the corresponding experimental values. An estimate of these parameters is thus obtained: [symbol] , [symbol] , [symbol] .

Advantageously, a polynomial regression could be used as in the first embodiment to estimate these parameters. This alternative will not be described again here.

The calibration phase is followed by an actual prediction phase, comprising steps 550-570 in FIG. 5B.

The prediction phase aims at predicting the shape of a three-dimensional object (having a given initial shape) when it has undergone the diffusion process for a period of time T.

In step 550, the equivalent radius, r₀^{′}, of the slice ( [symbol] =1) at the base of the object is calculated and the height of the object at the end of the diffusion process is determined, from the vertical morphing law, as in expression (18).

In step 553, the slices [symbol] are considered at normalised heights [symbol] , [symbol] =1, . . . , L. In this step, for each slice [symbol] a plurality of points N, [symbol] , i=1, . . . , N with coordinates ( [symbol] , [symbol] ) on the contour [symbol] of each slice are selected and the normal vectors to the curve [symbol] =( [symbol] , [symbol] ) at these points are determined. The points are advantageously chosen to be angularly equidistributed on [0,2π].

In step 555, the level curves [symbol] (x,y) [symbol] =1, . . . , L, are determined, verifying the constraints:

$$\begin{matrix} {f}^{′ℓ} ( {x}_{l}^{′ℓ} , {y}_{i}^{′ℓ} ) = 0 ; ∀ i = 1 , … , N & ( 39 \text{-} 1 ) \\ \frac{\partial {f}^{′ℓ}}{\partial x} ( {x}_{i}^{′ℓ} , {y}_{i}^{′ℓ} ) = {v}_{i}^{′ x , ℓ} , \frac{\partial {f}^{′ℓ}}{\partial y} ( {x}_{i}^{′ℓ} , {y}_{i}^{′ℓ} ) = {v}_{i}^{′ y , ℓ} ; ∀ i = 1 , … , N & ( 39 \text{-} 2 )\end{matrix}$$

In step 557, the spatial Fourier coefficients [symbol] (0) of the functions [symbol] (x,y) are calculated, where the value 0 indicates that the three-dimensional object is considered at the initial time before the diffusion process is applied. The fundamental spatial frequencies used for the calculation of the Fourier coefficients are the same as the calibration phase.

In step 560, the contours of the slices [symbol] =1, . . . , L at the end of the diffusion process are determined from the lateral morphing law. More precisely, the coefficients [symbol] (T) of the harmonics with rank \sqrt{m²+n²}>1 are calculated using (32), that is:

[symbol]

=(T)= [symbol] (T) [symbol] (0)avec|k|=\sqrt{(mkₓ)²+(nk_{y})²} (40)

with [symbol] (T)=exp(− [symbol] [symbol] T) where [symbol] , [symbol] were obtained in the calibration phase.

Similarly, the coefficients [symbol] (T) and [symbol] (T) are calculated by:

[symbol]

(T)= [symbol] · [symbol] (0) (41-1)

[symbol]

(T)= [symbol] · [symbol] (0) (41-2)

where the contraction coefficients [symbol] , [symbol] =1, . . . , L were obtained in the calibration phase.

In step 565, an inverse spatial Fourier transform of the coefficients [symbol] (T) is performed to calculate the level curve [symbol] (x,y):

$${f}^{′ℓ} ( x , y ) = {\sum }_{m , n} {f}_{m , n}^{′ℓ} exp ( j {k}_{x} mx + j {k}_{y} n y ) = 0 \qquad ( 42 )$$

Finally, in step 570, the shape of the three-dimensional object is reconstructed from the level curves of the slices [symbol] , [symbol] =1, . . . , L, obtained in step 565, these slices being now located at heights h′(T) [symbol] , [symbol] =1, . . . , L respectively.

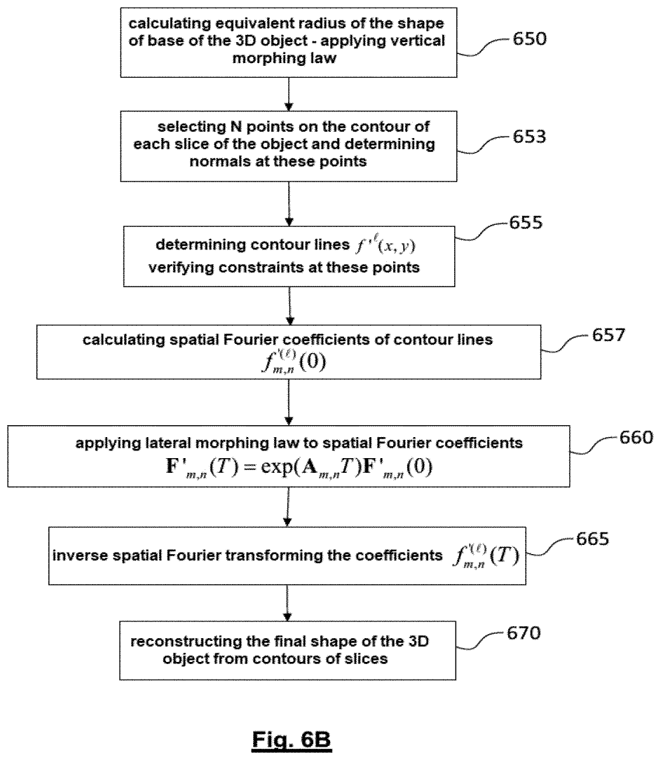

FIGS. 6A-6B represent the flowchart of a method for predicting the shape of a three-dimensional object that has undergone a diffusion process, according to an alternative of the second embodiment.

In this alternative, the slices of the three-dimensional object are no longer assumed to be independent and calibration is performed on all the slices of each sample. As previously, the calibration phase (FIG. 6A) is followed by the actual prediction phase (FIG. 6B).

Steps 610-643 are respectively identical to steps 541-543 of the second embodiment and their description will therefore be omitted.

In step 645, the parameters [symbol] , [symbol] , [symbol] are estimated, verifying for each of the samples:

F_{m,n}(T)=exp(A_{m,n},T)F_{m,n}(0)∀m,n\sqrt{m²+n²}>1 (43-1)

F_{0,1}(T)=exp(A_{0,1}t)F_{0,1}(0)+(I_{L}−exp(A_{0,1}T))F_{0,1}(∞) (43-2)

F_{1,0}(T)=exp(A_{1,0}t)+F_{1,0}(0)+(I_{L}−exp(A_{1,0}T))F_{1,0}(∞) (43-3)

where F_{m,n}(0) (resp. F_{m,n}(T)) is the vector having size L whose elements are [symbol] (0) (resp. [symbol] (T)) obtained in the calibration phase and A_{m,n} is the symmetrical tri-diagonal matrix with size L×L whose main diagonal terms are equal to − [symbol] [symbol] −C_{m,n}, [symbol] =1, . . . , L, and whose lower diagonal and upper diagonal terms are equal to C_{m,n}, where C_{m,n} is a coupling coefficient for the spatial harmonic with indices m,n between two successive slices of the sample. In practice, solving the system of equations (43-1), (43-2), (43-3) is done by curve fitting considering only the first of the serial expansion of the matrix exponentials.

An estimate of these parameters is thus obtained: [symbol] , [symbol] , [symbol] .

The calibration phase is followed by an actual prediction phase, comprising steps 650-670 in FIG. 6B.

The prediction phase consists of predicting, from the shape of a three-dimensional object at a given time t=0, the shape of the latter after application of a diffusion process for a given period of time T.

Steps 650-657 are respectively identical to steps 550-557 of the second embodiment.

Briefly, the equivalent radius, r₀^{′}, of the slice ( [symbol] =1) at the base of the object is calculated and the height of the object at the end of the diffusion process is determined according to (18) from the vertical morphing law.

The spatial Fourier coefficients [symbol] (0) of the slices [symbol] at normalised heights [symbol] , [symbol] =1, . . . , L are then calculated. This results in a plurality of vectors Q² having size L F′_{m,n}(0), where Q is the number of harmonics considered in the Fourier transform.

In step 660, the contours of the slices [symbol] =1, . . . , L at the end of the diffusion process are determined from the lateral morphing law. More precisely, the coefficients [symbol] (T) of the harmonics having rank \sqrt{m²+n²}>1 are calculated using (36), that is:

F_{m,n}^{′}(T)=exp(A_{m,n}T)F_{m,n}^{′}(0) (44)

where F_{m,n}^{′}(T) is the vector of spatial Fourier coefficients of the slices at normalised heights [symbol] , [symbol] =1, . . . , L;

and for the fundamentals, from (37-1) and (37-2):

F_{0,1}^{′}(T)=exp(A_{0,1}T)F_{0,1}^{′}(0)+(I_{L}−exp(A_{0,1}T))F_{0,1}^{′}(∞) (45-1)

F_{1,0}^{′}(T)=exp(A_{1,0}T)F_{1,0}^{′}(0)+(I_{L}−exp(A_{1,0},T))F_{1,0}^{′}(∞) (45-2)

In step 665, an inverse spatial Fourier transform of the coefficients [symbol] (T) obtained in the previous step is performed.

Finally, in step 670, the shape of the three-dimensional object is reconstructed from the level curves of the slices [symbol] , [symbol] =1, . . . , L, obtained in step 665, these slices now being located respectively at heights h′ (T) [symbol] , [symbol] =1, . . . , L.

The method for predicting the shape of a three-dimensional object, according to the first and second embodiments as well as their alternative set out above, allows for a considerable reduction in measurement runs as modelling of the vertical and lateral morphing laws requires only a relatively small number of samples.

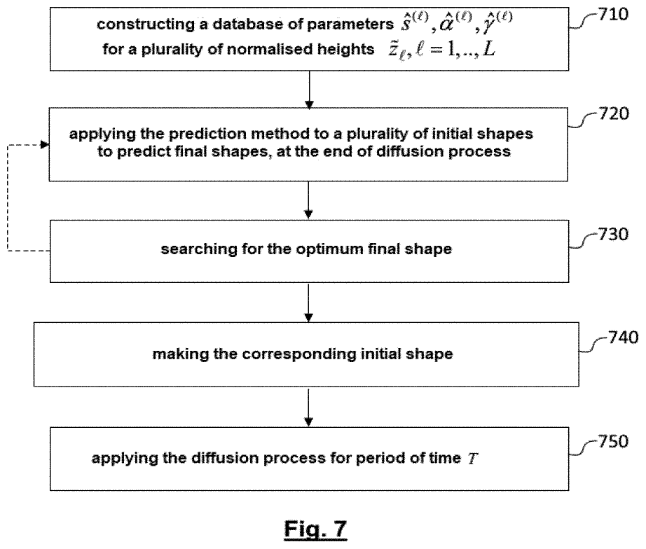

FIG. 7 represents the flowchart of a method for manufacturing a three-dimensional object of a given material and a predetermined shape set point.

The manufacturing method comprises a calibration phase, a prediction phase, an optimisation phase and an actual manufacturing phase.

In the calibration phase, 710, a database containing parameters [symbol] , [symbol] , [symbol] for a plurality of normalised heights [symbol] , [symbol] =1, . . . , L, is constructed from measurements of samples before and after a diffusion process with period of time T. This calibration phase may be that of the first embodiment or the second embodiment, or their alternatives. If necessary, the database can contain these parameters for a plurality of period of time values.

Once the database is constructed, a plurality of initial shapes of a three-dimensional object are tested in 720 and the prediction method described in steps 350-370 or 450-470 or 550-570 or 650-670, depending on the embodiment chosen, is applied to each of these shapes in order to predict shapes at the end of the diffusion process (if necessary taking different diffusion period of times into account), referred to as final shapes.

In an optimisation phase, 730, the final, so-called optimal shape is determined, which is closest to the shape set point relative to a predetermined distance.

If necessary, a plurality of final shapes closest to the shape set point may be selected and the corresponding initial shapes interpolated to obtain a new initial shape to be tested at 720. In this way, by successive iterations, an optimal initial shape can be obtained such that the distance between the corresponding final shape and the shape set point is then below a predetermined threshold.

Regardless of how the optimal final shape is obtained, in the manufacturing phase, 740, a three-dimensional object with the corresponding initial shape is produced, for example by 3D lithography or additive manufacturing, and the diffusion process is applied for the period of time stored in the database. At the end of the process, a three-dimensional object is obtained, whose shape is identical or close to the shape set point.

1. A method for predicting the shape of a three-dimensional object subjected to a diffusion process for a predetermined period of time, the method comprising:
a calibration phase in which a plurality of samples with different initial shapes undergo, for said determined period of time, the diffusion process, at the end of which the samples assume final shapes, and comprising, for each sample:
a) measuring the initial height of the sample and acquiring first contours of a plurality of horizontal slices of the sample in its initial shape, at heights normalised by the initial height;
b) measuring the final height of the sample and acquiring second contours of a same plurality of horizontal slices of the sample in its final form, at heights normalised by the final height, equal to said heights normalised by the final height;
c) estimating the parameters of a vertical morphing law for switching from the initial height to the final height and estimating the parameters of a lateral morphing law for switching from a representation, in a Fourier space, of the first contours to a representation, in the Fourier space, of the second contours;
a prediction phase comprising:
d) estimating the final height of said object from its initial height and the parameters of the vertical morphing law;
e) obtaining a representation in said Fourier space of a plurality of contours of the slices of the object in its initial form, at said normalised heights;
f) obtaining a representation in said Fourier space of a plurality of contours of the slices of the object in its final shape, at the normalised heights, from said representation of the slices of the object in its initial shape and the parameters of the lateral morphing law;
g) determining the contours of the plurality of slices of said object in its final form, at the normalised heights, from the representation of the contours of these slices in said Fourier space obtained in step (f);
h) obtaining the final shape of the three-dimensional object from the final height of said object and the contours of the slices of said object in its final shape, previously determined at the normalised heights.

2. The method for predicting the shape of a three-dimensional object according to claim 1, wherein the representation in said Fourier space of the first and second contours in step (c) as well as the representation, in the same space, of the contours of the slices of the object in its initial shape in step (f), are obtained by a curvilinear Fourier transform of these contours.

3. The method for predicting the shape of a three-dimensional object according to claim 2, wherein in step (g), determining the contours of the plurality of slices of said object in its final shape is achieved by an inverse curvilinear Fourier transform of the representation of the contours of these slices in said Fourier space obtained in step (f).

4. The method for predicting the shape of a three-dimensional object according to claim 1, wherein the representation in said Fourier space of the first and second contours in step (c) as well as the representation in this space of the contours of the slices of the object in its initial shape in step (f), are obtained by performing:
(f1) selecting a plurality of points of this contour, and determining the normals of this contour at these points;
(f2) calculating the coefficients of a two-dimensional spatial Fourier transform of a level curve function taking a zero value at the points thus selected and whose normals at these points are respectively equal to the normals of the contour at these same points.

5. The method for predicting the shape of a three-dimensional object according to claim 4, wherein in step (g) determining the contours of the plurality of slices of said object in its final shape is achieved by performing an inverse two-dimensional spatial Fourier transform of the coefficients calculated in step (f2).

6. The method for predicting the shape of a three-dimensional object according to claim 1, wherein the vertical morphing law is given by h(T)=h(0)H(r₀,T) where h(0) and h(T) are respectively the initial and final height of the sample, H(r₀,T) is a vertical morphing factor given by H(r₀,T)=ar₀ exp (−br₀) where a,b are positive parameters depending on the material of the sample and the period of time T of the diffusion process, and r₀ is the radius of an equivalent circle whose area is equal to the area of the base of the sample.

7. The method for predicting the shape of a three-dimensional object according to claim 2, wherein the lateral morphing law is given by [symbol] (T)= [symbol] (T) [symbol] (0)+(1− [symbol] )) [symbol] (∞) where [symbol] (0), [symbol] (T), [symbol] (∞) are the curvilinear harmonics having rank k of the contour of a slice [symbol] of the sample, respectively at initial instant, at the end of the period of time T of the diffusion process and at the end of an infinite diffusion time, [symbol] (T) is a lateral morphing factor given by [symbol] (T)=exp (− [symbol] [symbol] T) where [symbol] and [symbol] are positive parameters depending on the material of the sample and on the period of time T of the diffusion process.

8. The method for predicting the shape of a three-dimensional object according to claim 2, wherein the lateral morphing law is given by Φₖ (T)=exp(AₖT)Φₖ(0) where Φₖ(0) and Φₖ(T) are vectors having size L whose elements are the curvilinear harmonics having rank k>1 of the contours of L slices of the sample at the initial time and at the end of the period of time of the diffusion process respectively, and Aₖ is a symmetric tri-diagonal matrix having size L×L whose main diagonal terms are equal to − [symbol] [symbol] −Cₖ and whose lower and upper diagonal terms are equal to \dot{a} Cₖ, where [symbol] and [symbol] are positive parameters depending on the sample material and Cₖ is a coupling coefficient for the harmonic with rank k between two successive slices of the sample.

9. The method for predicting the shape of a three-dimensional object according to claim 4, wherein the lateral morphing law is given by [symbol] (T)= [symbol] (T) [symbol] (0)+(1− [symbol] (T))· [symbol] (∞), where [symbol] (0), [symbol] (T) and [symbol] (∞) are the spatial harmonics with indices m, n of the contour of a slice l of the sample, respectively at the initial instant, at the end of the period of time T of the diffusion process and at the end of an infinite diffusion time, [symbol] (T) is a lateral morphing factor given by [symbol] (T)=exp (− [symbol] [symbol] T) where [symbol] and [symbol] are positive parameters depending on the material of the sample and where |k|=\sqrt{(mkₓ)²+(nk_{y})²}, with kₓ=2π/Lₓ and k_{y}=2π/L_{y}, Lₓ, L_{y} being the dimensions of a rectangle including said contour.

10. The method for predicting the shape of a three-dimensional object according to claim 4, wherein the lateral morphing law is given by F_{m,n}(T)=exp(A_{m,n}T)F_{m,n}, where F_{m,n}(0) and F_{m,n}(t) are vectors having size L whose elements are the spatial harmonics with indices m,n of the contours of the L slices of the sample, respectively at initial instant and at the end of the period of time T of the diffusion process, A_{m,n} is a symmetrical tri-diagonal matrix having size L×L whose main diagonal terms are equal to − [symbol] [symbol] −C_{m,n} and whose lower diagonal and upper diagonal terms are equal to C_{m,n} where [symbol] and [symbol] are positive parameters depending on the sample material, C_{m,n} is a coupling coefficient for the spatial harmonic with indices m,n between two successive slices of the sample, and where |k|=\sqrt{(mkₓ)²+(nk_{y})²}, with kₓ=2π/Lₓ and k_{y}=2π/L_{y},Lₓ,L_{y} being the dimensions of a rectangle including said contours.

11. A method for manufacturing a three-dimensional object of a given material and having a given shape set point, comprising:
a calibration phase comprising constructing a database of parameters of a vertical morphing law and a lateral morphing law for a plurality of normalised heights of said samples from measurements of samples of said material, before and after a diffusion process with a period of time T;
applying the prediction method according to claim 1 to a plurality of initial shapes to predict their respective final shapes at the end of the diffusion process;
selecting the initial shape whose corresponding final shape is closest to said shape set point relative to a predetermined distance;
making a three-dimensional object having the initial shape thus selected and
applying the diffusion process for the period of time T to obtain a three-dimensional object having said shape set point.
